(19) United States
(12) Patent Application Publication
(10) Pub. No.: US 2006/0277491 A1
(43) Pub. Date: Dec. 7, 2006

(54) Information processing apparatus and display control method

(75) Inventor: Satoshi Kaneko, Iruma-gun (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/442,165

(22) Filed: May 30, 2006

(30) Foreign Application Priority Data
May 31, 2005 (JP) 2005-160045

(51) Int. Cl. G06F 17/00

(52) U.S. Cl. 715/788; 715/531

(57) ABSTRACT

According to one embodiment, an information processing apparatus capable of displaying a window on a display screen, includes: an input device which inputs an event for instructing a scale-up or a scale-down of an image displayed inside a window; a detection unit which detects the window set so as to perform zoom processing of the image displayed inside the window according to the event; and a zoom unit which performs zoom processing of the image displayed inside the detected window.

### CROSS-REFERENCE TO RELATED APPLICATIONS

This application is based upon and claims the benefit of priority from Japanese Patent Application No. 2005-160045, filed May 31, 2005, the entire contents of which are incorporated herein by reference.

### BACKGROUND

1. Field

One embodiment of the invention relates to an information processing apparatus capable of displaying plural windows on a display screen and a display control method used in the same apparatus.

2. Description of the Related Art

An information processing apparatus such as a personal computer generally has a window system capable of displaying plural windows on a display screen. Each of the windows is a defined area on the screen. Each of the windows has a work area, and images such as pictures or characters provided by an application program corresponding to its window are displayed in the work area.

The window system enables each of the windows to be resized and each of the windows to move on the display screen. An apparatus for changing a size of the window according to an operation of a mouse button is known as a technique for resizing the window (for example, see JP-A-2000-293287). In this apparatus, while the mouse button is pressed, a size of the window is gradually scaled up or down according to a lapse of its time.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view showing an outward appearance of a computer according to one embodiment of the invention;

FIG. 2 is an exemplary block diagram showing one example of a system configuration of the computer of FIG. 1;

FIG. 3 is an exemplary diagram showing one example of a configuration of a zooming utility program executed in the computer of FIG. 1;

FIG. 4 is an exemplary diagram showing an example of an application reference table used in the computer of FIG. 1;

FIG. 5 is an exemplary diagram showing an example of a command definition table used in the computer of FIG. 1;

FIG. 6 is an exemplary diagram showing an example of a display screen of the computer of FIG. 1;

FIG. 7 is an exemplary diagram showing one example of a situation in which the contents of display of the inside of a window on the display screen of FIG. 6 are scaled up by a depression operation of a scale-up button;

FIG. 8 is an exemplary diagram showing an example of a display screen of the computer of FIG. 1;

FIG. 9 is an exemplary diagram showing one example of a situation in which the contents of display of the inside of a window on the display screen of FIG. 8 are scaled down by a depression operation of a scale-down button;

FIG. 10 is an exemplary diagram showing an example of a display screen of the computer of FIG. 1;

FIG. 11 is an exemplary diagram showing one example of a situation in which a display image of a desktop on the display screen of FIG. 10 is scaled up by a depression operation of a scale-up button;

FIG. 12 is an exemplary diagram showing an example of a display screen of the computer of FIG. 1;

FIG. 13 is an exemplary diagram showing one example of a situation in which a display image of a desktop on the display screen of FIG. 12 is scaled down by a depression operation of a scale-down button;

FIG. 14 is an exemplary flowchart showing a procedure of scale-up/scale-down processing performed by the computer of FIG. 1;

FIG. 15 is an exemplary flowchart showing an example of a procedure of processing for detecting a window of a running application performed by the computer of FIG. 1;

FIG. 16 is an exemplary diagram showing an example of a display screen of the computer of FIG. 1;

FIG. 17 is an exemplary diagram showing a situation in which a window size and the contents of display of a window on the display screen of FIG. 16 are scaled up by a depression operation of a scale-up button;

FIG. 18 is an exemplary diagram showing an example of a display screen of the computer of FIG. 1;

FIG. 19 is an exemplary diagram showing a situation in which a window size and the contents of display of a window on the display screen of FIG. 18 are scaled down by a depression operation of a scale-down button;

FIG. 20 is an exemplary flowchart showing another example of a procedure of scale-up/scale-down processing performed by the computer of FIG. 1; and

FIG. 21 is an exemplary diagram showing one example of a window displayed on a display screen in the case of registering and setting a window targeted for zooming processing by a selection operation of a user.

### DETAILED DESCRIPTION

Various embodiments according to the invention will be described hereinafter with reference to the accompanying drawings. In general, according to one embodiment of the invention, an information processing apparatus capable of displaying a window on a display screen, includes: an input device which inputs an event for instructing a scale-up or a scale-down of an image displayed inside a window; a detection unit which detects the window set so as to perform zoom processing of the image displayed inside the window according to the event; and a zoom unit which performs zoom processing of the image displayed inside the detected window.

An embodiment of the invention will be described below with reference to the drawings.

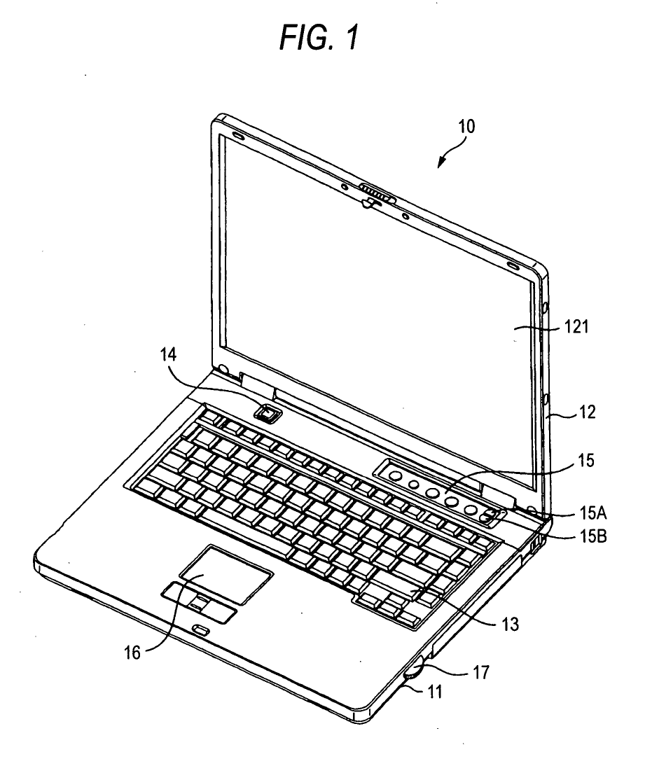

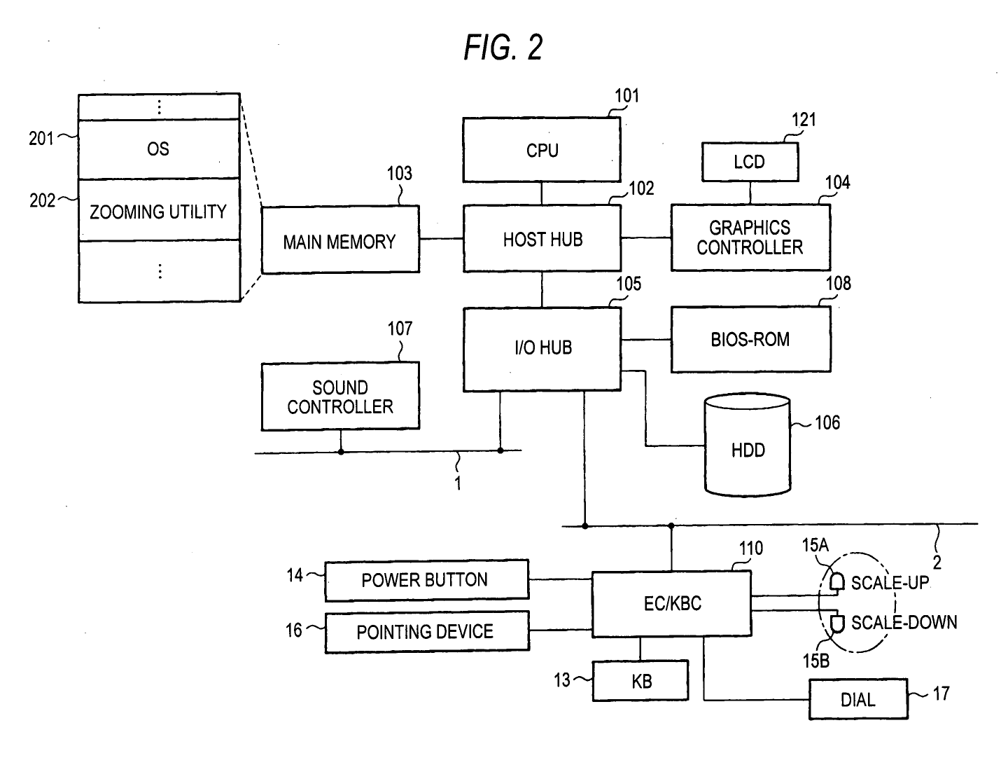

Referring first to FIGS. 1 and 2, a configuration of an information processing apparatus according to one embodiment of the invention will be described. This information processing apparatus is implemented as, for example, a notebook personal computer 10.

FIG. 1 is a perspective view in a state of opening a display unit of the notebook personal computer 10. The computer 10 includes a computer body 11 and a display unit 12. A display including an LCD (Liquid Crystal Display) 121 is incorporated into the display unit 12, and a display screen of its LCD 121 is located in approximately the center of the display unit 12.

The display unit 12 is rotatably mounted between an opened position and a closed position with respect to the computer body 11. The computer body 11 has a cabinet with a thin box shape. A keyboard 13, a power button 14 for turning on and off a power source of the computer 10, an input operation panel 15 and a touch pad 16, etc., are arranged on the upper surface of the computer body 11.

The input operation panel 15 is an input device for inputting an event corresponding to a pressed button, and includes plural buttons for respectively activating plural functions. A group of these buttons also include a scale-up button 15A and a scale-down button 15B.

The scale-up button 15A is a press button switch for inputting a zoom event for instructing a scale-up of an image displayed inside a window. Also, the scale-down button 15B is a press button switch for inputting a zoom event for instructing a scale-down of an image displayed inside a window. Each of the windows normally has a title bar, a menu bar and a work area. An image displayed in the work area of the window is targeted for a scale-up or a scale-down. The image displayed in the work area of the window includes a character as well as a picture (a graphics image, a photo image). That is, each of the display images of contents displayed in the work area is scaled up or down.

The touch pad 16 is a pointing device for instructing a position on a display screen of the LCD 121, and instructs a position of a pointer (also called a mouse cursor or a mouse pointer) displayed on the display screen. The pointer (hereinafter called the mouse cursor) displayed on the display screen moves on the display screen according to an operation of the touch pad 16.

In the present embodiment, when a zoom event is inputted, a window (also called an application window) registered and set by a user is automatically detected and an image displayed inside the detected window is scaled up or down. Specifically, when the scale-up button 15A is depressed, a display size of each of the elements (characters, pictures) forming the image (hereinafter called a display image) displayed inside the window registered and set is scaled up. Also, when the scale-down button 15B is depressed, a display size of each of the elements (characters, pictures) forming the display image inside the window registered and set is scaled down. In the embodiment, a desktop screen is also handled as one of the windows. When the desktop screen is registered and set, a display size of each of the icons (including icon images and text indicating names of the icons) arranged on the desktop screen is scaled up or down.

In environment in which plural windows are displayed on the LCD 121, a user may operate an input of data such as text or a command to an active window while viewing a display image of another inactive window. The active window is a window currently targeted for input of the command and text. The active window is displayed in the foreground. When one window is clicked by an operation of the touch pad 16, the clicked window becomes a new active window. By only moving a mouse cursor from an active window to an inactive window, switching of the active window is not performed.

Also, a dial 17 is rotatably disposed in the side of the computer body 11. This dial 17 also functions as an input device for inputting a zoom event in a manner similar to the scale-up button 15A and the scale-down button 15B described above. The dial 17 inputs a zoom event for instructing either a scale-up or a scale-down of a display image inside a window according to a rotation direction of the dial.

Next, one example of a system configuration of the computer 10 will be described with reference to FIG. 2.

As shown in FIG. 2, the computer 10 is provided with a CPU 101, a host hub 102, main memory 103, a graphics controller 104, an I/O hub 105, a hard disk drive (HDD) 106, a sound controller 107, BIOS-ROM 108, and an embedded controller/keyboard controller IC (EC/KBC) 110, etc.

The CPU 101 is a processor disposed for controlling an action of the computer 10, and executes an operating system (OS) 201 and various application/utility programs loaded from the hard disk drive (HDD) 106 to the main memory 103. The OS 201 has a window system for displaying plural windows on a display screen. Also, the CPU 101 executes a BIOS (Basic Input Output System) stored in the BIOS-ROM 108.

In the computer 10, a zooming utility program 202 is previously installed as one of the utility programs. This zooming utility program 202 is a program for performing zoom processing for scaling up or down a display image inside a window. The zooming utility program 202 is automatically activated, for example, at the time of activating the computer 10. The zooming utility program 202 can be implemented as, for example, a TSR (terminate-and-stay-resident program).

The host hub 102 is a bridge device for making connection between the I/O hub 105 and a local bus of the CPU 101. A memory controller for controlling access to the main memory 103 is built into the host hub 102. The graphics controller 104 controls the LCD 121 used as a display monitor of the computer 10. The graphics controller 104 has video memory (VRAM), and displays display data drawn in the video memory by an OS/application program on the LCD 121.

The I/O hub 105 controls each of the devices on a PCI (Peripheral Component Interconnect) bus 1 and each of the devices on an LPC (low pin count) bus 2. Also, an IDE (Integrated Drive Electronics) controller for controlling the HDD 106 is built into the I/O hub 105.

The sound controller 107 is present on the PCI bus 1. This sound controller 107 is a PCI device for functioning as a sound source. The embedded controller/keyboard controller IC (EC/KBC) 110 is present on the LPC bus 2.

The embedded controller/keyboard controller IC (EC/KBC) 110 is a one-chip microcomputer into which an embedded controller for power management and a keyboard controller for controlling the keyboard (KB) 13 and the pointing device (touch pad) 16 are integrated. This embedded controller/keyboard controller IC (EC/KBC) 110 has a function of powering on and off the computer 10 according to an operation of the power button 14 by a user.

Further, the embedded controller/keyboard controller IC (EC/KBC) 110 has a function of detecting a depression operation of each of the scale-up button 15A and the scale-down button 15B by a user and a function of detecting a rotation operation of the dial 17 by a user.

When the scale-up button 15A is depressed, the embedded controller/keyboard controller IC (EC/KBC) 110 notifies the zooming utility program 202 that a zoom event (scale-up event) for instructing a scale-up of a display image of a window occurs using, for example, an interrupt signal to the CPU 101.

Also, when the scale-down button 15B is depressed, the embedded controller/keyboard controller IC (EC/KBC) 110 notifies the zooming utility program 202 that a zoom event (scale-down event) for instructing a scale-down of a display image of a window occurs using, for example, an interrupt signal to the CPU 101.

Also, when the dial 17 is rotated, the embedded controller/keyboard controller IC (EC/KBC) 110 notifies the zooming utility program 202 that a scale-up event or a scale-down event occurs according to a rotation direction of its dial 17 using, for example, an interrupt signal to the CPU 101.

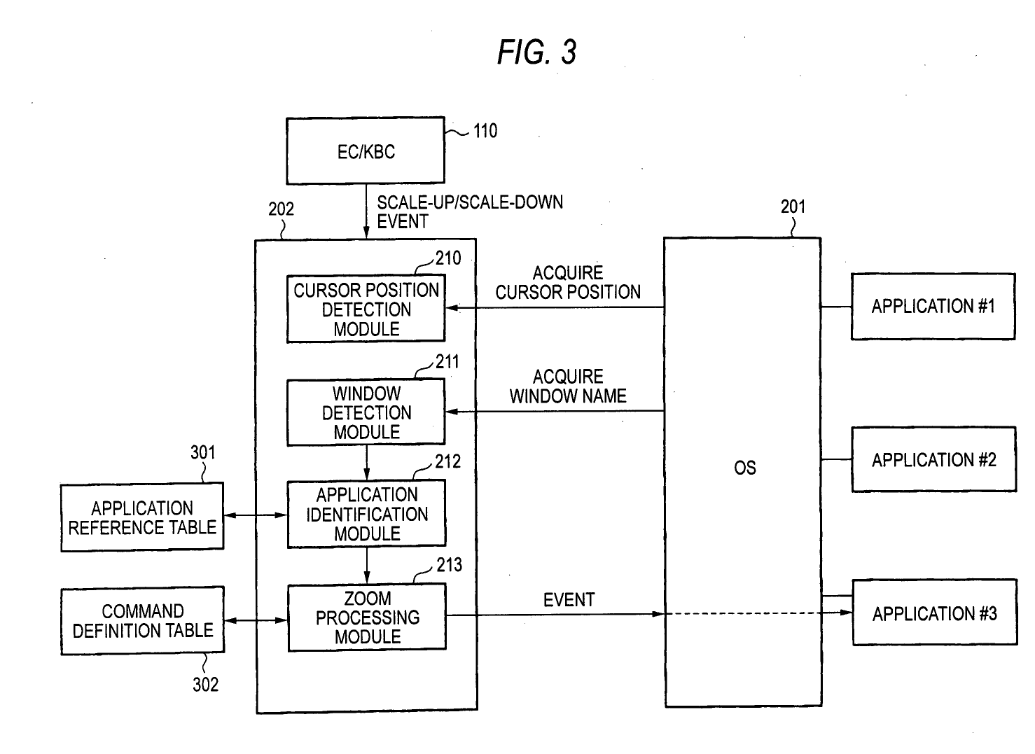

Next, a configuration of the zooming utility program 202 will be described with reference to FIG. 3.

The zooming utility program 202 includes a cursor position detection module 210, a window detection module 211, an application identification module 212 and a zoom processing module 213.

The cursor position detection module 210 is a module for detecting the present position (X and Y coordinates) of a mouse cursor. The cursor position detection module 210 detects the present position (X and Y coordinates) of the mouse cursor by acquiring the present mouse cursor position (X and Y coordinates) from the OS 201.

The window detection module 211 is a module for detecting a window of a running application when occurrence of a zoom event of a scale-up or a scale-down is notified from the EC/KBC 110. The window detection module 211 acquires a window name of the running application from the OS 201 by inquiring the window name of the running application at the OS 201.

The application identification module 212 is a module for identifying an application program corresponding to a window of a running application. This application identification module 212 identifies the application program corresponding to the window of the running application detected by the window detection module 211 by referring to an application reference table 301.

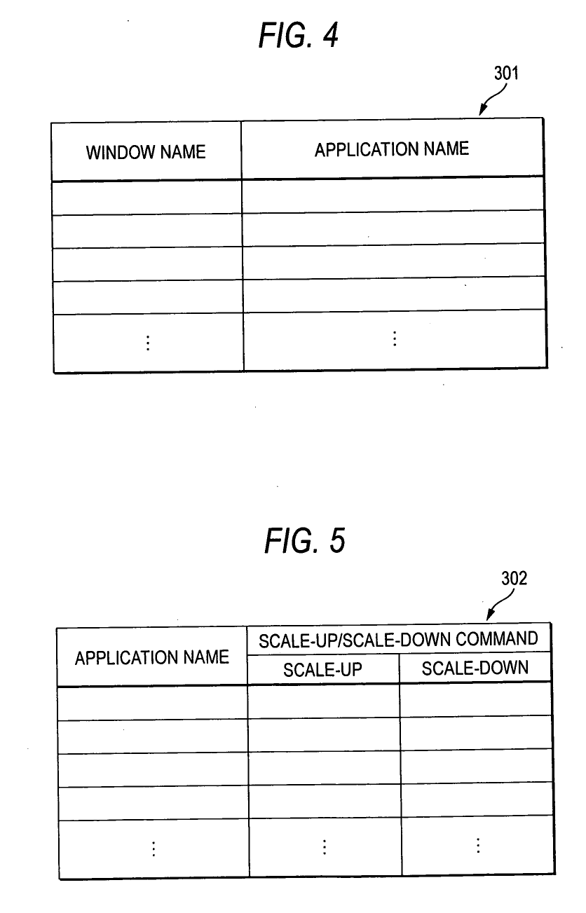

In the application reference table 301, application program names corresponding to the window names are defined every window name as shown in FIG. 4. By a selection operation of a user, a window targeted for zooming processing is set (registered and set) and the set contents are reflected on the contents defined in the application reference table 301. The way of registering and setting the window targeted for zooming processing by the selection operation of the user will be described later.

The zoom processing module 213 is a module for performing zoom processing for scaling up or down a display image inside the window detected by the window detection module 211. This zoom processing module 213 performs the zoom processing described above using a zoom function of scaling up or down the display image, which each of the application programs has. An event (or called a message) for activating the zoom function of the application program differs every application program. As a result of this, the zoom processing module 213 performs command processing different every application program by referring to a command definition table 302.

In the command definition table 302, a scale-up command and a scale-down command corresponding to the application program are defined every application program name as shown in FIG. 5. The scale-up command indicates an event for activating the zoom function (scale-up) of the corresponding application program, and the scale-down command indicates an event for activating the zoom function (scale-down) of the corresponding application program. As the event, for example, codes, etc., indicating combinations of plural keys such as “Ctrl+PageUp” or “Ctrl+PageDown” can be used.

The zoom processing module 213 issues a scale-up/scale-down command corresponding to an application program identified by the application identification module 212 to the identified application program as an event for activating the zoom function which the identified application program has.

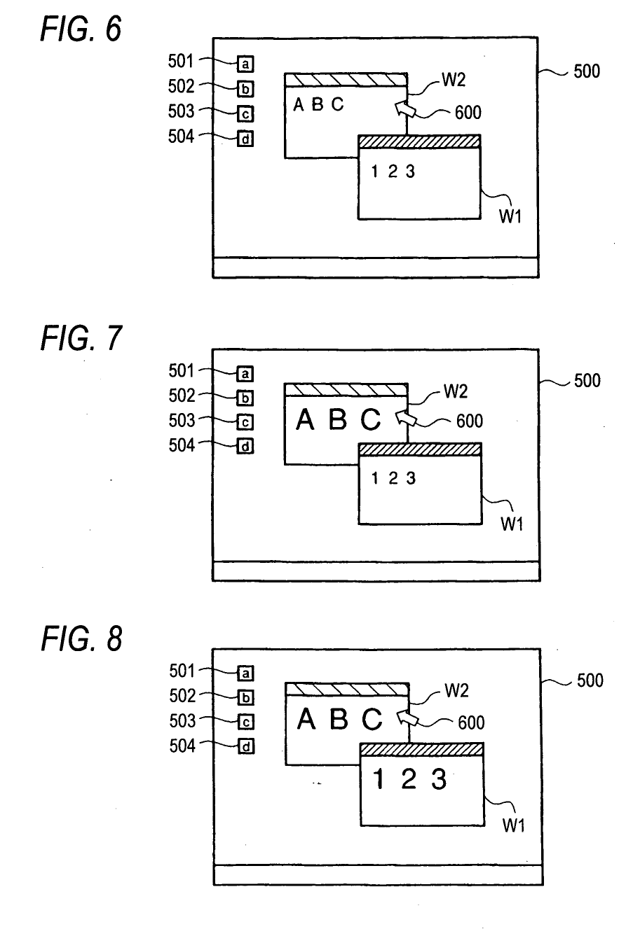

Next, how to scale up or down a display image of a window will be described with reference to FIGS. 6 to 13.

FIG. 6 shows an example of a display screen of the LCD 121. A desktop screen 500 is displayed on the display screen of the LCD 121. A group of icons 501 to 504 are arranged on this desktop screen 500. Further, two windows W1, W2 are displayed on the desktop screen 500. Contents such as characters, pictures are displayed in each of the work areas of the windows W1, W2. In FIG. 6, the window W1 is a window which is not registered and set, and the window W2 is a window which is already registered and set. The window W1 is displayed in the foreground, and text, etc., inputted from the keyboard 13 are displayed in window W1.

When the scale-up button 15A is depressed in a state in which the inactive window W2 is present just under a mouse cursor 600, a display image of the inside of the window W2 is scaled up. The display screen after the display image is scaled up is FIG. 7. A display size of contents such as characters displayed inside the window W2 is scaled up as shown in FIG. 7. When a picture such as a graphic image is present inside the window W2 as contents, a display size of its picture is also scaled up. A window size of the window W2 does not change. Also, the window W1 is the window which is not registered and set, so that a display image of the inside of the window W1, that is, a display size of each of the contents displayed inside the window W1 remains a constant size. The display image of the inside of the window W2, that is, the display size of each of the contents displayed inside the window W2 is stepwise scaled up at a constant scaling factor every time the scale-up button 15A is depressed.

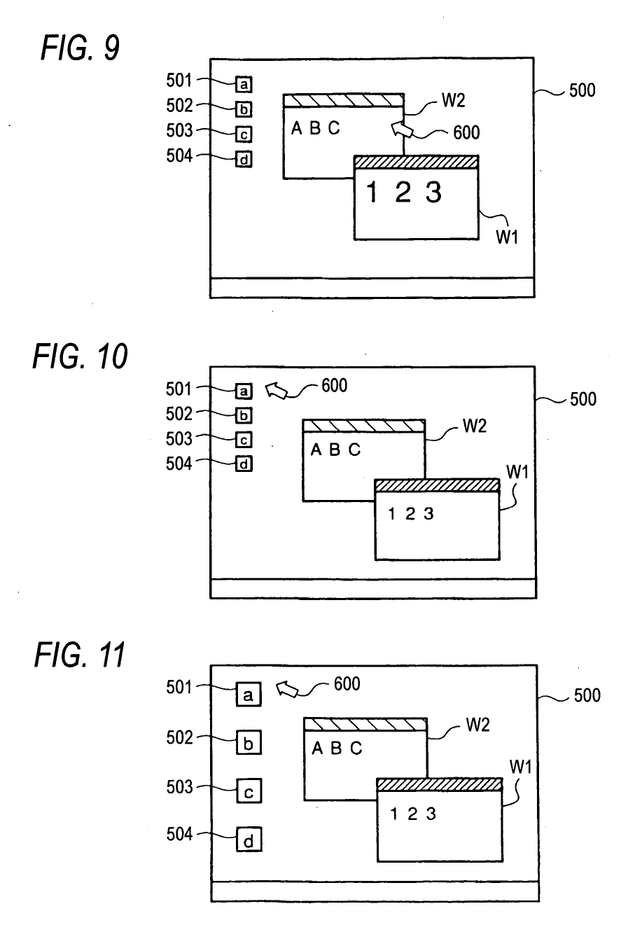

A situation in which a display size of the inside of a window is scaled down is shown in FIGS. 8 and 9. When the scale-down button 15B is depressed in a state in which the registered and set W2 is present just under the mouse cursor 600 as shown in FIG. 8, a display image of the inside of the window W2 is scaled down. The display screen after the display image is scaled down is FIG. 9. A window size of the window W2 does not change. Also, the window W1 is the window which is not registered and set, so that a display image of the inside of the window W1, that is, a display size of each of the contents displayed inside the window W1 remains a constant size. The display image of the window W2 is stepwise scaled down at a constant scaling factor every time the scale-down button 15B is depressed.

Thus, in the embodiment, the display sizes of the contents displayed inside the window registered and set can be scaled up or down.

A situation in which a display image of the desktop screen 500 is scaled up is shown in FIGS. 10 and 11. When the scale-up button 15A is depressed in a state in which the desktop screen 500 is registered and set as shown in FIG. 10, a display size of each of the icons 501 to 504 on the desktop screen 500 is scaled up. The display screen after the display size is scaled up is FIG. 11. The display size of each of the icons 501 to 504 is stepwise scaled up at a constant scaling factor every time the scale-up button 15A is depressed.

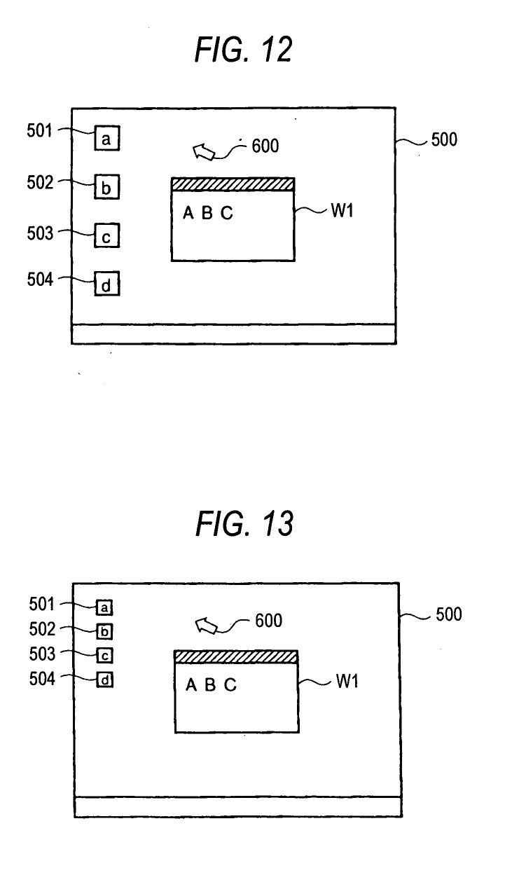

A situation in which a display image of the desktop screen 500 is scaled down is shown in FIGS. 12 and 13. When the scale-down button 15B is depressed in a state in which the desktop screen 500 is registered and set as shown in FIG. 12, a display size of each of the icons 501 to 504 on the desktop screen 500 is scaled down. The display screen after the display size is scaled down is FIG. 13. The display size of each of the icons 501 to 504 is stepwise scaled down at a constant scaling factor every time the scale-down button 15B is depressed.

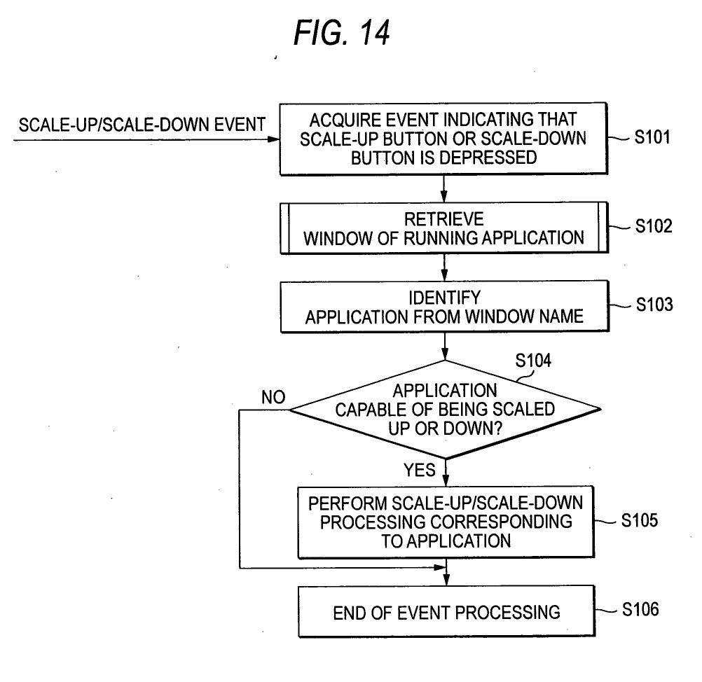

Next, a procedure of processing performed by the CPU 101 under control of the zooming utility program 202 will be described with reference to a flowchart of FIG. 14.

When the scale-up button 15A or the scale-down button 15B is depressed, the CPU 101 acquires a zoom event indicating that the scale-up button 15A or the scale-down button 15B is depressed from the EC/KBC 110 (step S101). The CPU 101 performs the following processing by executing the zooming utility program 202.

The CPU 101 first performs processing for retrieving a window of a running application (step S102). In this step S102, a window name of the running application is detected.

The CPU 101 identifies an application program corresponding to the window name of the running application detected in step S102 by referring to the application reference table 301 described above (step S103). Then, the CPU 101 determines whether or not the application program corresponding to the window name of the running application detected is an application program capable of being scaled up or down by the zooming utility program 202 (step S104).

An application program of which an application program name is stored in the application reference table 301 is the application program capable of being scaled up or down by the zooming utility program 202, and an application program of which the application program name is not stored is an application program incapable of being scaled up or down by the zooming utility program 202.

When the application program corresponding to the window name of the running application detected is the application program incapable of being scaled up or down (NO of step S104), the CPU 101 ends execution of processing corresponding to the zoom event (step S106).

On the other hand, when the application program corresponding to the window name of the running application detected is the application program capable of being scaled up or down by the zooming utility program 202 (YES of step S104), the CPU 101 performs scale-up/scale-down processing corresponding to its application program (step S105).

In this step S105, the CPU 101 acquires a scale-up/scale-down command corresponding to the application program name identified in step S103 from the command definition table 302 described above. Then, the CPU 101 sends an event indicated by the acquired scale-up/scale-down command to the application program identified in step S103 through the OS 201 or directly. As a result of this, a zoom function of its application program is performed and a display size of each of the contents forming a display image of the inside of a window corresponding to the application program is scaled up or down.

Incidentally, in some application programs, an event for activating the zoom function of the application program is not defined. In this case, processing for rewriting environment setting information (environment setting information indicating a display size of a character and environment setting information indicating a display size of an image) about the application program identified in step S103 may be performed.

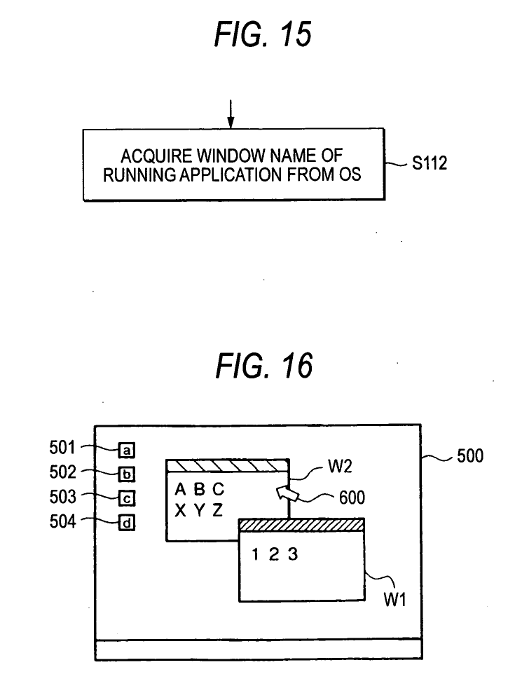

A flowchart of FIG. 15 shows an example of a specific processing procedure performed in step S102 of FIG. 14.

The CPU 101 inquires a window name (window handle) of the running application at the OS 201 and acquires its window name (window handle) from the OS 201 (step S112).

Next, processing for scaling up or down not only a display image of the inside of a window of a running application but also a size of its window will be described with reference to FIGS. 16 to 19.

When only a display image of a window is scaled up while maintaining a size of the window, there are cases where a part of a character or a picture displayed before the scale-up is not displayed after the scale-up. All of the character or the picture displayed before the scale-up of the display image can also be displayed after the scale-up of the display image by scaling up not only the display image of the inside of the window but also a size of its window according to a scale-up factor of the display image.

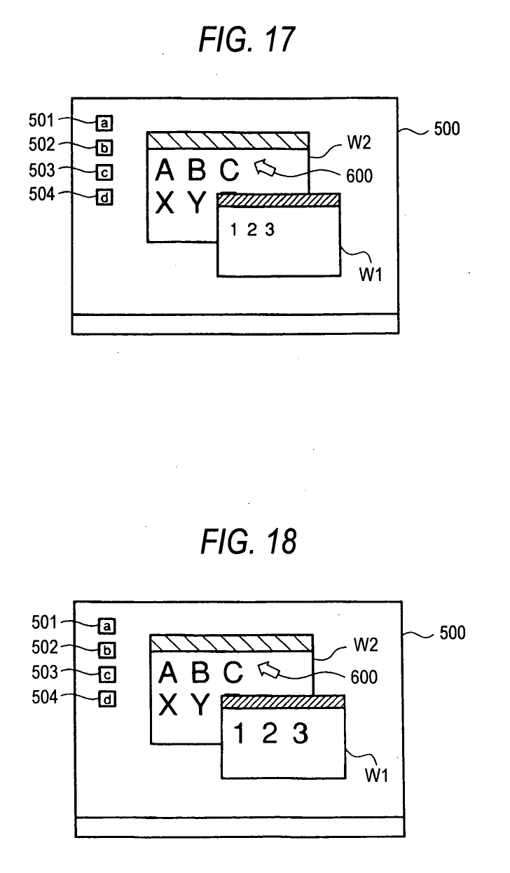

When the scale-up button 15A is depressed in a state in which a window W2 is registered as shown in FIG. 16, a display image of the inside of the window W2 is scaled up and also a window size of the window W2 is scaled up. The display screen after being scaled up is FIG. 17. A display size of each of the characters of the inside of the window W2 is scaled up as shown in FIG. 17. When a picture such as a graphic image is present inside the window W2, a display size of its picture is also scaled up. Further, the window W2 is resized so that the window size of the window W2 is also scaled up at the same scaling factor as a scale-up factor of the display image of the inside of the window W2.

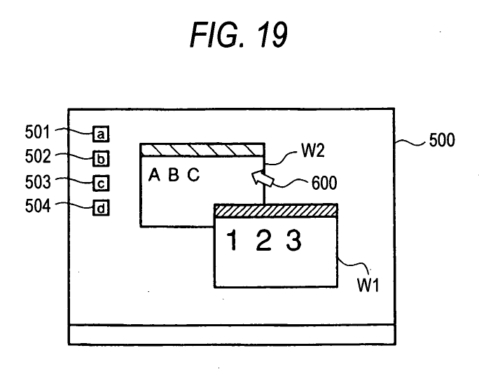

Also, when the scale-down button 15B is depressed in a state in which a window W2 is registered as shown in FIG. 18, a display image of the inside of the window W2 is scaled down and also a window size of the window W2 is scaled down. The display screen after being scaled down is FIG. 19. A display size of each of the characters of the inside of the window W2 is scaled down as shown in FIG. 19. When a picture such as a graphic image is present inside the window W2, a display size of its picture is also scaled down. Further, the window W2 is resized so that the window size of the window W2 is also scaled down at the same scaling factor as a scale-down factor of the display image of the inside of the window W2.

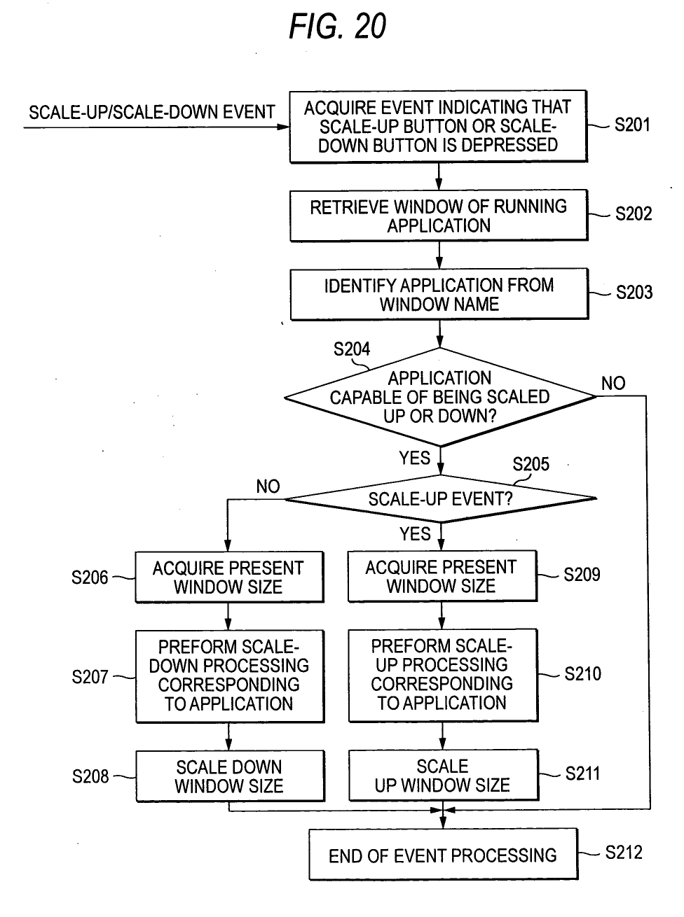

Next, a procedure of processing for scaling up or down a display image and a window size performed by the CPU 101 under control of the zooming utility program 202 will be described with reference to a flowchart of FIG. 20.

When the scale-up button 15A or the scale-down button 15B is depressed, the CPU 101 acquires a zoom event indicating that the scale-up button 15A or the scale-down button 15B is depressed from the EC/KBC 110 (step S201). The CPU 101 performs the following processing by executing the zooming utility program 202.

The CPU 101 first performs processing for retrieving a window of a running application (step S202).

The CPU 101 identifies an application program corresponding to a window name of the running application detected in step S202 by referring to the application reference table 301 described above (step S203). Then, the CPU 101 determines whether or not the application program corresponding to the window name of the running application detected is an application program capable of being scaled up or down by the zooming utility program 202 (step S204).

An application program of which an application program name is stored in the application reference table 301 is the application program capable of being scaled up or down by the zooming utility program 202, and an application program of which the application program name is not stored is an application program incapable of being scaled up or down by the zooming utility program 202.

When the application program corresponding to the window name of the running application detected is the application program capable of being scaled up or down (YES of step S204), the CPU 101 determines whether the zoom event is a scale-up event or a scale-down event (step S205).

When the zoom event is the scale-down event (NO of step S205), the CPU 101 detects a window size of a window by acquiring a window size of the window detected in step S202 from the OS 201 (step S206). Then, the CPU 101 performs scale-down processing corresponding to the application program identified in step S203 (step S207).

In this step S207, the CPU 101 acquires a scale-down command corresponding to the application program name identified in step S203 from the command definition table 302 described above. Then, the CPU 101 sends an event indicated by the acquired scale-down command to the application program identified in step S203 through the OS 201 or directly. As a result of this, a zoom function of its application program is performed and a display image of the inside of a window corresponding to the application program is scaled down.

Subsequently, the CPU 101 performs resizing processing for scaling down the window size of the window detected in step S202 so that the window size of the window of the running application detected in step S202 is scaled down according to a scale-down factor of the display image (step S208). In this step S208, the CPU 101 calculates a window size after the resizing from, for example, the window size acquired in step S206 and the scale-down factor of the display image. Then, the CPU 101 requests resizing of the window detected in step S202 from the OS 201 so that the window size of the window detected in step S202 becomes the calculated size.

When the zoom event is the scale-up event (YES of step S205), the CPU 101 detects a window size of a window by acquiring a window size of the window detected in step S202 from the OS 201 (step S209). Then, the CPU 101 performs scale-up processing corresponding to the application program identified in step S203 (step S210).

In this step S210, the CPU 101 acquires a scale-up command corresponding to the application program name identified in step S203 from the command definition table 302 described above. Then, the CPU 101 sends an event indicated by the acquired scale-up command to the application program identified in step S203 through the OS 201 or directly. As a result of this, a zoom function of its application program is performed and a display image of the inside of a window corresponding to the application program is scaled up.

Subsequently, the CPU 101 performs resizing processing for scaling up the window size of the window detected in step S202 so that the window size of the window of the running application detected in step S202 is scaled up according to a scale-up factor of the display image (step S211). In this step S211, the CPU 101 calculates a window size after the resizing from, for example, the window size acquired in step S209 and the scale-up factor of the display image. Then, the CPU 101 requests resizing from the OS 201 so that the window size of the window detected in step S202 becomes the calculated size.

Incidentally, when the OS 201 has a function of resizing a corresponding window size at a scale-up/scale-down factor specified by a parameter included in a resizing request, it is unnecessary to calculate a window size after the resizing. Therefore, the processing of step S206 and the processing of step S209 can be skipped.

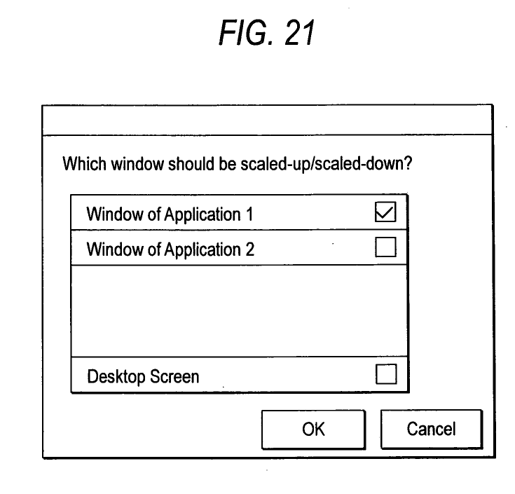

Next, registration and setting of a window targeted for zooming processing by a selection operation of a user will be described with reference to FIG. 21.

When a window targeted for zooming processing is registered and set, a user uses a screen as shown in FIG. 21. For example, when the user wants to scale up or down a display image of the inside of a window of “application 1”, a checkmark is placed in a checkbox for selecting “application 1”. When the checkmark is placed in the checkbox and an OK button is pressed, the contents registered and set by the user are reflected on the application reference table 301.

The example of using the scale-up/scale-down buttons 15A, 15B or the dial 17 as the device for inputting the zoom event has been described above, but combinations of particular keys on the keyboard 13 can also be used as the zoom event. Also, for example, a menu screen for selecting plural functions including execution of a zoom event according to a button operation of the pointing device 16 may be displayed on a display screen.

Also, the function of scale-up/scale-down processing of the embodiment is implemented by a computer program, so that an effect similar to that of the embodiment can be obtained easily by only installing its computer program into a normal computer through a computer-readable storage medium.

The invention is not limited to the foregoing embodiments but various changes and modifications of its components may be made without departing from the scope of the present invention. Also, the components disclosed in the embodiments may be assembled in any combination for embodying the present invention. For example, some of the components may be omitted from all the components disclosed in the embodiments. Further, components in different embodiments may be appropriately combined.

What is claimed is:

1. An information processing apparatus capable of displaying a window on a display screen, comprising:
an input device which inputs an event for instructing a scale-up or a scale-down of an image displayed inside a window;
a detection unit which detects the window set so as to perform zoom processing of the image displayed inside the window according to the event; and
a zoom unit which performs zoom processing of the image displayed inside the detected window.

2. The information processing apparatus as claimed in claim 1, wherein the detection unit comprises a detecting section which detects a window of a running application program according to the event.

3. The information processing apparatus as claimed in claim 1, wherein the zoom unit comprises an identifying section which identifies an application program corresponding to the detected window, and an issuing section which issues an event for activating a zoom function of scaling up or down the image displayed inside the window corresponding to the application program to the identified application program, the identified application program having the zoom function.

4. The information processing apparatus as claimed in claim 1, further comprising a changing section which changes a size of the detected window so as to scale up the size of the detected window according to a scale-up factor of the image when the image displayed inside the detected window is scaled up by the zoom processing.

5. The information processing apparatus as claimed in claim 1, further comprising a changing section which changes a size of the detected window so as to scale down the size of the detected window according to a scale-down factor of the image when the image displayed inside the detected window is scaled down by the zoom processing.

6. A display control method for controlling an image displayed inside a window arranged on a display screen of an information processing apparatus, the method comprising the steps of:
inputting an event for instructing a scale-up or a scale-down of the image displayed inside the window;
detecting the window set so as to perform zoom processing of the image displayed inside the window according to the inputted event; and
performing zoom processing of the image displayed inside the detected window.

7. The display control method as claimed in claim 6, wherein the detection step includes detecting a window of a running application program according to the event.

8. The display control method as claimed in claim 6, wherein the performing step includes a step of identifying an application program corresponding to the detected window, and a step of issuing an event for activating a zoom function of scaling up or down the image displayed inside the window corresponding to the application program to the identified application program, the identified application program having the zoom function.

9. The display control method as claimed in claim 6, further comprising a step of changing a size of the detected window so as to scale up the size of the detected window according to a scale-up factor of the image when the image displayed inside the detected window is scaled up by the zoom processing.

10. The display control method as claimed in claim 6, further comprising a step of changing a size of the detected window so as to scale down the size of the detected window according to a scale-down factor of the image when the image displayed inside the detected window is scaled down by the zoom processing step.
